(19) United States
(12) Patent Application Publication
(10) Pub. No.: US 2024/0058808 A1
(43) Pub. Date: Feb. 22, 2024

(54) APPARATUS FOR TESTING A LIQUID SPECIMEN

(71) Applicant: CLINICAL DESIGN TECHNOLOGIES LIMITED, Devon (GB)

(72) Inventor: Oliver BLACKWELL, Devon (GB)

(21) Appl. No.: 18/268,194

(22) PCT Filed: Dec. 10, 2021
(86) PCT No.: PCT/GB2021/000139

§ 371 Date: Jun. 16, 2023

(30) Foreign Application Priority Data
Dec. 17, 2020 (GB) 2019974.1

(51) Int. Cl. B01L 3/00

(52) U.S. Cl. CPC B01L 3/5023; B01L 3/502715; B01L 2300/069; B01L 2200/026; B01L 2300/0825

(57) ABSTRACT

Apparatus (2) for testing a liquid specimen (4), which apparatus (2) comprises: (i) a collection container (6) for collecting the liquid specimen (4); (ii) a test container (8) for testing the liquid specimen (4); (iii) response portions (10) which are in the test container (8) and which are for responding to contact with the liquid specimen (4) to give at least one test result; and (iv) transfer means (12) which enables the collection container (6) to be connected to the test container (8) for transferring at least some of the liquid specimen (4) from the collection container (6) to the test container (8) such that the transferred liquid specimen (4) is able to contact the response portions (10) in the test container (8) and enable the response portions (10) to react to the liquid specimen (4) for the testing and characterised in that: (V) the apparatus (2) is such that the liquid specimen (4) is transferred from the collection container (6) to the test container (8); (vi) the apparatus (2) is such that the container (8), whereby the liquid specimen (4) that has been transferred to the test container (8) and that has been used by the response portions (10) in the test container (8) is able to be tested with or without the collection container (6) being present.

This invention relates to apparatus for testing a liquid specimen.

A liquid specimen from a patient is often tested to diagnose or monitor one or more medical conditions of the patient. Typically the liquid specimen is handled and this presents clinical infection risks. Also, the liquid specimen may be unpleasant to handle, for example if the liquid specimen is urine.

It is an aim of the present invention to avoid or reduce the above mentioned problems.

Accordingly, in one non-limiting embodiment of the present invention there is provided apparatus for testing a liquid specimen, which apparatus comprises:
(i) a collection container for collecting the liquid specimen;
(ii) a test container for testing the liquid specimen;
(iii) response portions which are in the test container and which are for responding to contact with the liquid specimen to give at least one test result; and
(iv) transfer means which enables the collection container to be connected to the test container for transferring at least some of the liquid specimen from the collection container to the test container such that the transferred liquid specimen is able to contact the response portions in the test container and enable the response portions to react to the liquid specimen for the testing,
   and characterised in that:
(v) the apparatus is such that the liquid specimen is transferred from the collection container to the test container;
(vi) the apparatus is such that the liquid specimen that is transferred to the test container and is no longer required is transferred back to the collection container; and
(vii) the transfer means enables the collection container to be separated from the test container, whereby the liquid specimen that has been transferred to the test container and that has been used by the response portions in the test container is able to be tested with or without the collection container being present.

The apparatus of the present invention is advantageous in that the liquid specimen, for example urine, is able to be tested without the need for undue exposure to the liquid specimen and the resultant clinical infection risks. Furthermore, where the liquid specimen is unpleasant, for example in the case of urine, the apparatus of the present invention enables the liquid specimen to be tested and subsequently disposed of as pleasantly and as safely as possible.

The apparatus may be one in which the apparatus is such that the liquid specimen is transferred from the collection container to the test container by gravity. Alternatively, the apparatus may be one in which the apparatus is such that the liquid specimen is transferred from the collection container to the test container by suction. Any suitable suction means, for example a syringe-type suction means, may be used to effect the transfer by the suction.

The apparatus may be one in which the test container is sealable after the collection container has been separated from the test container. This helps to avoid liquid specimen getting on the outside of the test container and thereby being unpleasant for a person operating the apparatus and/or causing an infection risk for the person operating the apparatus. The test container and/or the collection container may be sealed by sealing means such for example as a valve or valves.

Preferably, the gravity is provided by causing the test container to be lower than the collection container. This may be effected by inverting the collection container and placing it on top of the test container. Other ways of causing the test container to be lower than the collection container may be employed.

The apparatus may be one in which the transfer means comprises a first part and a second part, in which the first part and the second part are connectable together to form a sealed connection, and in which the first part and the second part are separable from each other to enable the test container to be separated from the collection container after the liquid specimen that has contacted the response portions has been transferred back to the collection container, whereby testing of the liquid specimen is able to be conducted without the collection container being present. The first and second parts may be connectable together by a push fit. Other types of connection means may be employed so that, for example, the first and second parts may be connected together by connection means comprising a screw connection means.

The apparatus may be one in which the collection container comprises a lid and a body portion, and in which the lid is a removable lid which is a screw fit on the body portion.

The response portions may be in a line. Alternatively, the response portions may be such that they define other shapes, for example a circle. The response portions may be read by eye or by electronic apparatus.

Embodiments of the invention will now be described solely by way of example and with reference to the accompanying drawings in which:

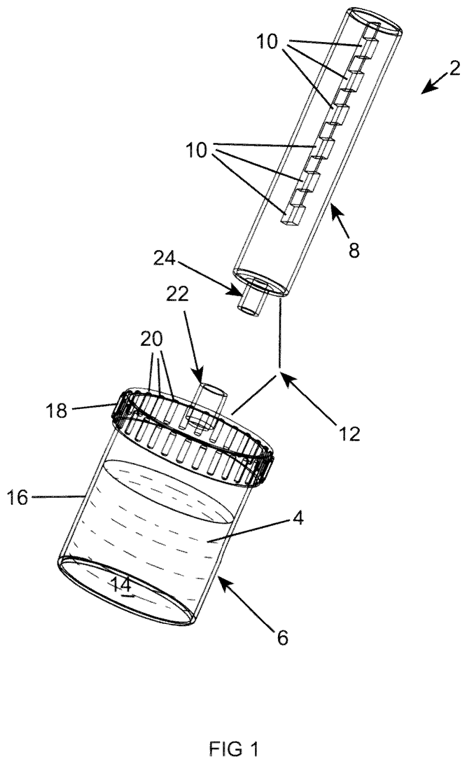

FIG. 1 shows first apparatus of the present invention for testing a liquid specimen, with the apparatus being in an initial stage of use;

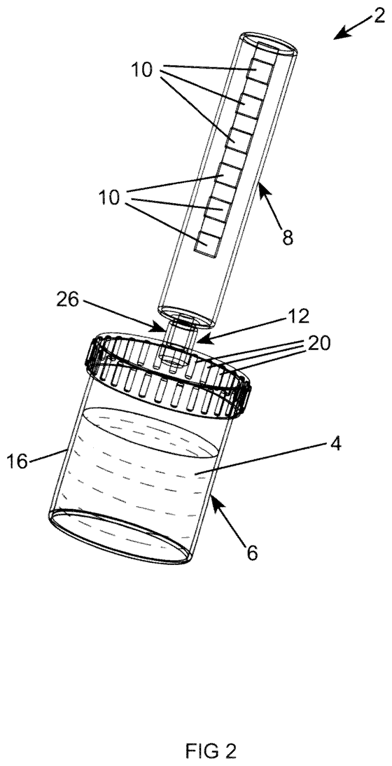

FIG. 2 shows the apparatus of FIG. 1 in a next stage of use;

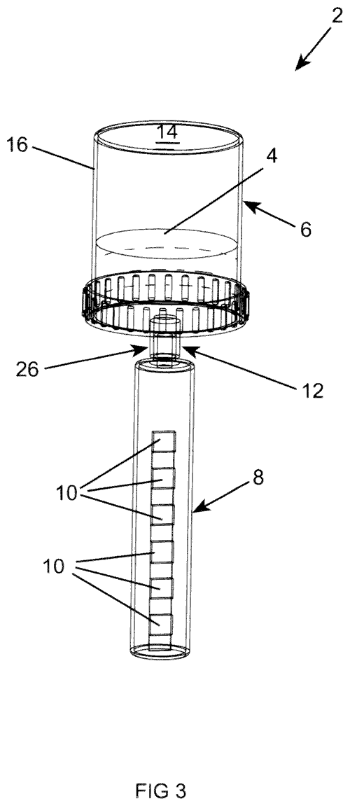

FIG. 3 shows the apparatus as shown in FIG. 2 in a next stage of use;

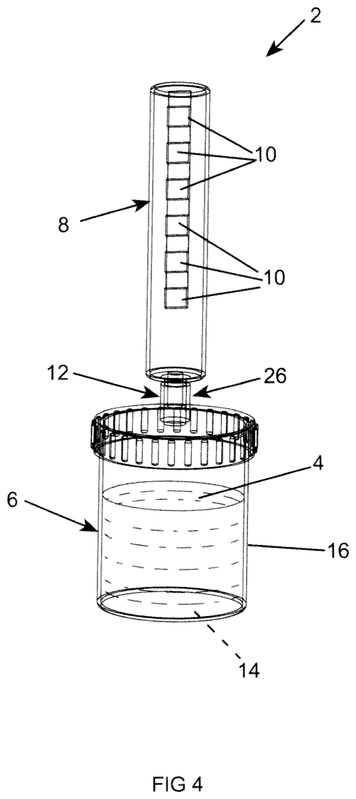

FIG. 4 shows the apparatus as shown in FIG. 3 in a next stage of use;

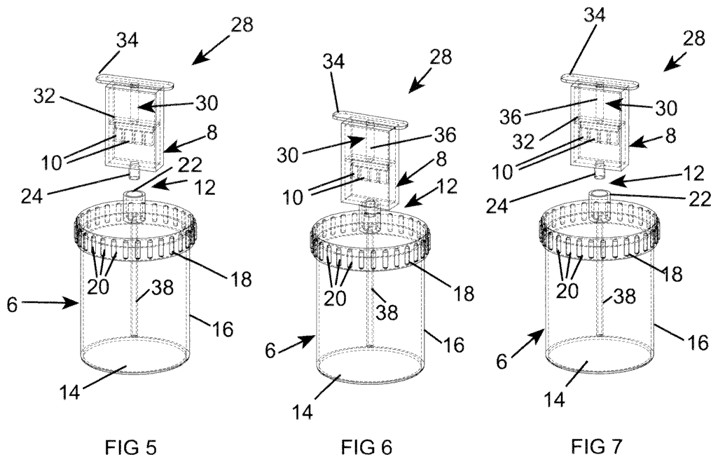

FIG. 5 shows second apparatus of the present invention for testing a liquid specimen, with the apparatus being shown with component parts about to be connected together;

FIG. 6 shows the apparatus of FIG. 5 but with the component parts being connected together;

FIG. 7 shows the apparatus of FIG. 6 but with the connected component parts having been disconnected;

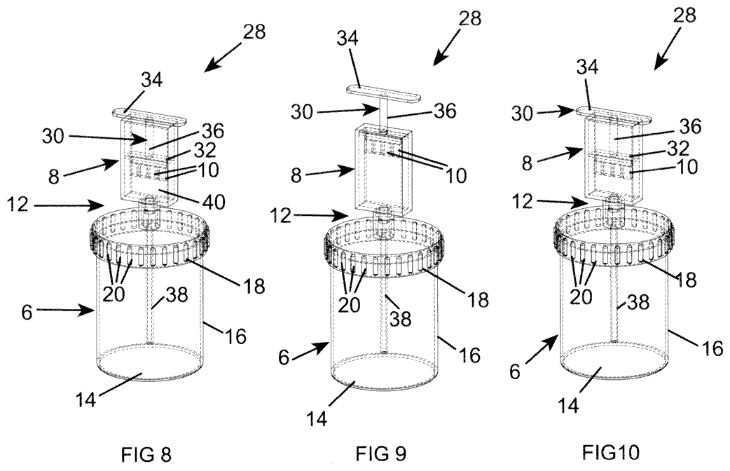

FIG. 8 shows the apparatus as in FIG. 6, with suction means forming part of the apparatus being in a ready-for-use condition;

FIG. 9 shows the apparatus as in FIG. 8 but with the suction means having been operated and in a position in which liquid specimen has been drawn into a test container forming part of the apparatus; and

FIG. 10 shows the apparatus as in FIG. 9 but with the suction means having been operated to return excess liquid specimen to a collection container forming part of the apparatus.

Referring to FIGS. 1-4, there is shown apparatus 2 for testing a liquid specimen 4. The apparatus 2 comprises a collection container 6 for containing the liquid specimen 4. The apparatus 2 further comprises a test container 8 for testing the liquid specimen 4.

Response portions 10 are in the test container 8. The response portions 10 are for responding to contact with the liquid specimen 4 to give at least one test result.

The apparatus 2 comprises transfer means 12 which enables the collection container 6 to be connected to the test container 8. The transfer means 12 is for transferring at least some of the liquid specimen 4 from the collection container 6 to the test container 8 such that the transferred liquid specimen 4 is able to contact the response portions 10 in the test container 8 and enable the response portions 10 to react to the liquid specimen 4 for the testing.

The apparatus 2 is such that liquid specimen 4 is transferred from the collection container 6 to the test container 8 by gravity.

The apparatus 2 is also such that the liquid specimen 4 that has been transferred to the test container 8 and is no longer required is transferred back to the collection container 6.

The transfer means 12 enables the collection container 6 to be separated from the test container 8. The response portions 10 in the test container 8 can then be viewed with or without the collection container 6 being separated from the test container 8.

In use of the apparatus as shown in FIGS. 1-4, the gravity is provided by causing the test container 8 to be lower than the collection container 6.

The collection container 6 comprises a body portion 16 and a lid 18 which is a screw fit on the top of the body portion 16. The lid 18 is provided with ribs 20 for enabling the lid 18 easily to be gripped and screwed onto the body portion 16 and also unscrewed from the body portion 16. When the lid 18 is unscrewed from the body portion 16 and the collection container 6 is standing on its base 14, then the collection container 6 may be provided with the liquid specimen 4. The liquid specimen 4 may be provided in the collection container 6 from a larger collection container not shown, for example in the form of a bed pan, or the liquid specimen 4 may be provided direct from a patient into the collection container 6. When the body portion 16 has the required amount of the liquid specimen 4, then the lid 18 can be screwed onto the body portion 16.

FIG. 1 shows the apparatus 2 in an initial stage of use, with the test container 8 about to be connected to the collection container 6.

FIG. 2 shows the apparatus 2 in a condition in which the test container 8 has been connected to the collection container 6.

FIG. 3 shows the connected test container 8 and the collection container 6 turned upside down from the position shown in FIG. 2.

FIG. 4 shows the connected test container 8 and the collection container 6 turned upside down from the position shown in FIG. 3.

More specifically and with reference to FIGS. 1-4, FIG. 2 shows how the collection container 6 and the test container 8 have been moved from the position shown in FIG. 1 and have been brought into engagement with each other. At least some of the liquid specimen 4 from the collection container 6 is then able to be transferred to the test container 8 such that the transferred liquid specimen 4 is able to contact the response portions 10 in the test container 8 and enable the response portions 10 to react to the liquid specimen 4 for the testing. Thus, in the position shown in FIG. 3, the liquid specimen is transferred from the collection container 6 to the test container 8 by gravity. FIG. 4 shows the apparatus 2 inverted from the position shown in FIG. 3. In the position shown in FIG. 4, the liquid specimen that has been transferred to the test container 8 and is no longer requires transfer by gravity back to the collection container 6.

The transfer means 12 is such that it enables the collection container 6 to be separated from the test container 8. This separation is basically a reverse action of that required to connect the collection container 6 to the test container 8. As can be appreciated from a comparison of FIGS. 1 and 2, the connection of the collection container 6 to the test container 8 may be by a simple push fit. In an alternative embodiment, the connection may be by a screwing action. Other types of connection means may be employed. The separation of the collection container 6 from the test container 8 is typically effected by simply reversing the method of connection, for example by pulling the collection container 6 from the test container 8 if the connection has been by means of a pushing action, or by unscrewing the collection container 6 from the test container 8 if the connection has been by way of a screwing action.

As can best be appreciated from FIG. 1, the transfer means 12 is such that it comprises a first part 22 and a second part 24. The first part 22 and the second part 24 are connectable together to form a sealed connection 26 as shown in FIGS. 2-4. The sealed connection 26 is effected by pushing the first part 22 over the top of the second part 24. The first part 22 and the second part 24 are separable from each other by a pulling action in order to enable the test container 8 to be separated from the collection container 6 after the liquid specimen 4 that has contacted the response portions 10 has been transferred back to the collection container 6. After the separation of the test container 8 from the collection container 6, examination of the response portions 10 is able to be conducted without the collection container 6 being present. This facilitates the testing of the liquid specimen 4, for example enabling the test container 8 to be handled more easily than if is also comprises the collection container 6.

As shown in FIGS. 1-4, the response portions 10 are in a line.

The apparatus 2 is easily able to be used. Contact with the liquid specimen 4 is able to be substantially avoided. The collection container 6 is easily able to be filled prior to the testing. The collection container 6 is easily able to be disposed of after the testing. The transfer of the liquid specimen 4 back to the collection container 6 is advantageous in that excess liquid specimen 4 is not in the test container 8 when the test container 8 is being used in its testing mode. This helps to avoid the response portions 10 being subject to too much liquid specimen 4 which might cause test results to be inaccurate.

Referring now to FIGS. 5-10, there is shown second apparatus 28 of the present invention. Similar parts as in the apparatus 2 have been given the same reference numerals for ease of comparison and understanding. In FIGS. 5-10, the liquid specimen 4 has been omitted for ease of illustration.

In FIGS. 5-10, it will be seen that the apparatus 28 is such that the liquid specimen is transferred from the collection container 6 to the test container 8 by suction. More specifically, the apparatus 28 comprises suction means 30 which operates to transfer the liquid specimen 4 from the collection container 6 to the test container 8. The suction means 30 comprises a piston 32 which is connected to a handle 34 by a rod 36.

FIG. 5 shows the apparatus 28 in a connect mode of use, with the transfer means 12 being such that the first part 22 is about to be connected to the second part 24. FIG. 6 shows the first and second parts 22, 24 having been connected together. FIG. 7 shows the first and the second parts 22, 24 having been disconnected.

FIG. 8 shows the apparatus 28 with the collection container 6 connected to the test container 8 and being in a position ready for use. Advantageously, there may be a gap 40 below the response portions 10 which may contain air which could be used to help soak the response portions 10 in combination with the presence of the liquid specimen. The gap 40 may enable the creation of an agitation effect of liquid specimen and air for aiding the soaking of the response portions 10. The gap 40 may be advantageous when the liquid specimen is removed from the test container 8 by the response portions 10 being elevated above the bottom of the test container 6, whereby the response portions 10 are not subject to too much liquid specimen 4 which might cause an inaccuracy in test results.

FIG. 9 shows the apparatus of FIG. 8 having been operated to draw liquid specimen from the collection container 6 into the test container 8. This has been effected by pulling the handle 34 of the suction means 30 upwardly away from the test container 8 in order to cause a suction in the test container 8 and thereby draw the liquid specimen from the collection container 6 upwardly through a tube 38, through the transfer means 12 and into the test container 8.

FIG. 10 shows the apparatus as in FIG. 9 but with the suction means 30 having been further operated in order to return excess liquid specimen in the test container 8 back to the collection container 6. This excess liquid specimen is transferred back into the collection container 6 via the transfer means 12 and the tube 38. The transfer of excess liquid specimen back into the collection container 6 ensures that the response portions 10 are correctly soaked, and they are not over soaked or under soaked by the liquid specimen. Thus the accuracy of the response obtained from the response positions 10 is not adversely compromised by over soaking or under soaking the response portions 10. At this stage of operation of the apparatus 28, the collection container 6 with any residual liquid specimen in it is not required. It is thus able to be separated from the test container 8 as shown in FIG. 7. The separated test container 8 is then able to be used to read the response portions, either in situ or being sent to another place for the reading.

The first apparatus 2 and the second apparatus 28 advantageously operate such that the response portions 10 are able to be contacted with the liquid specimen 4. Upon contact with the liquid specimen 4, the response portions 10 change colour to indicate abnormalities in the liquid specimen 4. In order to operate effectively, the response portions 10 need to be exposed to the liquid specimen 4 and then excess liquid specimen 4 removed. Where the excess liquid specimen 4 is not removed, the performance of the response portions 10 can be compromised.

It is to be appreciated that the embodiments of the invention described above with reference to the accompanying drawings have been given by way of example only and that modifications may be effected. Thus, for example, the collection container 6, the test container 8 and the response portions 10 may be of shapes other than those shown. The response portions 10 may be arranged in another pattern, for example a circle rather than the illustrated line. Other types of transfer means 12 may be employed including, for example, a screw-operated transfer means. Other types of suction means 30 may be employed. The liquid specimen 4 shown in the drawings and being tested is urine. Other types of liquid specimen 4 than urine may be employed. Individual components shown in the drawings are not limited to use in their drawings and they may be used in other drawings and in all aspects of the invention. The invention also extends to the individual components mentioned and/or shown above, taken singly or in any combination.

1-9. (canceled)

10. Apparatus for testing a liquid specimen, which apparatus comprises:
(i) a collection container for collecting the liquid specimen;
(ii) a test container for testing the liquid specimen;
(iii) response portions which are in the test container and which are for responding to contact with the liquid specimen to give at least one test result; and
(iv) transfer means which enables the collection container to be connected to the test container for transferring at least some of the liquid specimen from the collection container to the test container such that the transferred liquid specimen is able to contact the response portions in the test container and enable the response portions to react to the liquid specimen for the testing,
and characterised in that:
(v) the apparatus is such that the liquid specimen is transferred from the collection container to the test container;
(vi) the apparatus is such that the liquid specimen that is transferred to the test container and is no longer required is transferred back to the collection container; and
(vii) the transfer means enables the collection container to be separated from the test container, whereby the liquid specimen that has been transferred to the test container and that has been used by the response portions in the test container is able to be tested with or without the collection container being present.

11. Apparatus according to claim 10, in which the apparatus is such that the liquid specimen is transferred from the collection container to the test container by gravity.

12. Apparatus according to claim 10, in which the apparatus is such that the liquid specimen is transferred from the collection container to the test container by suction.

13. Apparatus according to claim 10, in which the test container is sealable after the collection container has been separated from the test container.

14. Apparatus according to claim 10, in which the gravity is provided by causing the test container to be lower than the collection container.

15. Apparatus according to claim 10, in which the transfer means comprises a first part and a second part, in which the first part and the second part are connectable together to form a sealed connection, and in which the first part and the second part are separable from each other to enable the test container to be separated from the collection container after the liquid specimen that has contacted the response portions has been transferred back to the collection container, whereby testing of the liquid specimen is able to be conducted without the collection container being present.

16. Apparatus according to claim 15 in which the first and second parts are connected together by a push fit.

17. Apparatus according to claim 10, in which the collection container comprises a lid and a body portion, and in which the lid is a removable lid which is a screw fit on the body portion.

18. Apparatus according to claim 10, in which the response portions are in a line.

19. Apparatus for testing a liquid specimen, the apparatus comprises a collection container for containing a liquid specimen, the apparatus further comprises a test container for testing the liquid specimen, response portions are in the test container, the response portions are for responding to contact with the liquid specimen to give at least one test result, the collection container can be connected to the test container and liquid specimen can transferred from the collection container to the test container by inverting the collection container and the test container together whilst connected such that the transferred liquid specimen is able to contact the response portions in the test container and enable the response portions to react to the liquid specimen for the testing, and liquid specimen can be transferred from the test container to the collection container by inverting the collection container and the test container together whilst connected, whereby excess liquid specimen is not in the test container when the test container is being used in a testing mode.

20. Apparatus according to claim 19, in which transfer means enables the collection container to the connected to the test container.

21. Apparatus according to claim 20, in which the transfer means comprises a first part and a second part.

22. Apparatus according to claim 21, in which the first part and the second part are connectable together to form a sealed connection.

23. Apparatus according to claim 21 or claim 22, in which the first part and the second part are separable from each other.

24. Apparatus for testing a liquid specimen, which apparatus comprises a collection container for collecting the liquid specimen a test container for testing the liquid specimen, response portions which are in the test container and which are for responding to contact with the liquid specimen to give at least one test result, and transfer means which enables the collection container to be connected to the test container for transferring at least some of the liquid specimen from the collection container to the test container such that the transferred liquid specimen is able to contact the response portions in the test container and enable the response portions to react to the liquid specimen for the testing, the liquid specimen is transferred from the collection container to the test container, and the liquid specimen that is transferred to the test container and is no longer required is transferred back to the collection container, in which liquid specimen is transferred from the collection container to the test container by suction.

25. Apparatus according to claim 24, in which the apparatus comprises suction means which operates to transfer the liquid specimen from the collection container to the test container.

26. Apparatus according to claim 25, in which the suction means comprises a piston which is connected to a handle by a rod.

27. Apparatus according to claim 24, in which there is a gap below the response portions which contains air to help soak the response portions in combination with the presence of the liquid specimen, the gap enabling the creation of an agitation effect of liquid specimen and air for aiding the soaking of the response portions.

28. Apparatus according to claim 24, in which the response portions are elevated above the bottom of the test container.

29. Apparatus according to claim 24, in which the suction means is operable to return excess liquid specimen in the test container back to the collection container.
